(19) United States
(12) Patent Application Publication
(10) Pub. No.: US 2008/0083614 A1
(43) Pub. Date: Apr. 10, 2008

(54) Pressurized electrolyzer stack module

(76) Inventors: Dana Ray Swalla, Schenectady, NY (US); Richard Scott Bourgeois, Albany, NY (US); Donald Joseph Buckley, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/540,722

(22) Filed: Sep. 29, 2006

(51) Int. Cl. H01M 8/02; H01M 8/10; C25B 9/00

(52) U.S. Cl. 204/242; 429/32; 429/34

(57) ABSTRACT

A structural reinforcement for a pressurized plastic electrochemical cell stack is described with a first endplate and a second endplate, wherein the first endplate and the second endplate are each connected to a structural reinforcement along an axial direction such that the reinforcement extends through the first endplate and the second endplate and provides for compressing the first endplate and the second endplate against a bilithic or monolithic plastic electrochemical cell stack internal to the reinforcement, thereby sealing a gas generation cell within the reinforcement and thus providing enhanced creep resistance of the electrochemical cell stack.

### BACKGROUND OF THE INVENTION

The disclosure relates generally to electrochemical cell structures, and more specifically, to electrochemical cell structures having a plastic internal stack configuration, wherein the plastic internal stacks are prevented from leaking and restrained from creep caused by internal pressure during operation.

Electrochemical cells are energy conversion devices that are usually classified as either fuel cells or electrolyzers. By way of example, electrolysis cells can function as hydrogen generators by electrolytically decomposing water to produce hydrogen and oxygen gases. Fuel cells use the hydrogen by electrochemically reacting a hydrogen gas with an oxidant across an exchange membrane or electrolyte to generate electricity and produce water.

Alkaline electrolysis systems have been commercially available for several decades. Direct current voltage of about 1.7V to about 2.2V is applied to two electrodes that are positioned within a liquid electrolyte. At the positive electrode, oxygen is produced and at the negative electrode, hydrogen forms. An ion-permeable diaphragm keeps the gases separated.

Conventional electrochemical systems currently have many individual component parts including multiple electrode pairs, diaphragms, gaskets, bolts and other miscellaneous pieces that add to the complexity of the system assembly and drive the manufacturing costs up. For example, hydrogen generating electrochemical cell structures are manufactured with metal plates normally bolted together manually, with gaskets used between the plates to electrically insulate them from one another. The materials are normally expensive and assembly requires intensive and therefore high labor costs.

The general configuration and fabrication difficulties of conventional electrochemical systems that include stack assemblies are discussed in reference to FIG. 1. As shown, a typical stack assembly 10 includes a plurality of repeating units 12. Each repeat unit 12 includes an anode 14, a bipolar plate 16, a cathode 18, and a diaphragm 20. Any large-scale implementation of an alkaline electrolysis stack may include a hundred or more repeat units 12. Each repeat unit 12 requires electrical coupling between the anode 14, the bipolar plate 16, and the cathode 18, also commonly referred to as the electrode assembly 22. Direct current voltage 24 is applied to the anode 14 and the cathode 16 in the presence of an electrolyte (not shown), which for alkaline electrolysis is typically a potassium hydroxide solution. Each electrode assembly 22 must be separated by a diaphragm 20, primarily to keep the hydrogen and oxygen gases being generated from mixing between adjacent electrode assemblies 22. All of the repeat units 12 within a stack must be positioned within some type of housing and surrounded by non-conductive gasketing. Sealing technologies, piping or manifolds to distribute the electrolyte and to capture the hydrogen and oxygen gases. Hundreds of possibly thousands of connections and bolts or other fasteners are used to assemble this type of stack, further impacting the fabrication costs.

Newly developed electrochemical cell structures have involved the use of stack housings formed of non-conductive materials to achieve high chemical resistance and low assembly cost. However, the use of non-conductive materials, e.g., plastics, introduces materials that are not creep resistant and are therefore impractical for stacks with internal pressure. Internal pressure is an advantage in electrolysis because it raises the system efficiency and lowers the cost and potential necessity of post-stack compressors.

Accordingly, there is a need for a low cost electrochemical cell structure in which plastic stack housings are utilized and resists pressure related creep.

### SUMMARY OF THE INVENTION

This disclosure describes structural reinforcements for electrochemical cell stack modules comprising one or more non-conductive frames. In one embodiment, an electrochemical cell stack module comprises an electrochemical cell stack comprising one or more non-conductive frames, wherein the one or more non-conductive frames support at least one of an anode, a cathode, a top diaphragm, and a lower diaphragm of a repeat plate; and a structural reinforcement configured for containing the electrochemical cell stack, the structural reinforcement comprising a first rigid member, a second rigid member and at least one connector fixedly attached to the first and second rigid members along an axial or longitudinal direction and adapted to compress the first rigid member and the second rigid member against each end of the electrolyzer.

In another embodiment, the electrochemical cell stack module comprises an electrochemical cell stack comprising one or more non-conductive frames, wherein the one or more non-conductive frames support at least one of an anode, a cathode, a top diaphragm, and a lower diaphragm of a repeat plate; and a structural reinforcement configured for containing the electrochemical cell stack, the structural reinforcement comprising a cylindrical sleeve having an inner diameter equal to or slightly larger than the cylindrically shaped electrochemical cell stack.

In yet another embodiment, the electrochemical cell stack module comprises a cylindrically shaped electrochemical cell stack comprising one or more non-conductive frames, wherein the one or more non conductive frames support at least one of an anode, a cathode, a top diaphragm, and a lower diaphragm of a repeat plate; and a structural reinforcement configured for containing the electrochemical cell stack, the structural reinforcement comprising a cylindrical sleeve having an inner diameter equal to or slightly larger than the cylindrically shaped electrochemical cell stack, a first rigid member disposed against one end of the cylindrical sleeve, a second rigid member disposed against an other end of the cylindrical sleeve.

### BRIEF DESCRIPTION OF THE DRAWINGS

The disclosure and embodiments thereof will become apparent from the following description and the appended drawings, in which the like elements are numbered alike:

FIG. 1 is a prior art schematic representation of an alkaline electrolysis system.

FIG. 2 is a partial exploded perspective view of an electrochemical cell stack that includes non-conductive frames for supporting various components of the electrolyzer.

FIG. 3 is perspective view of an electrode insert for the electrochemical cell stack of FIG. 2.

FIG. 4 is a perspective view of end caps for the electrochemical cell stack of FIG. 2.

FIG. 5 is a top view of the electrochemical cell stack of FIG. 2.

FIG. 6 is a side view of the electrochemical cell stack shown in FIG. 5.

FIG. 7 is a perspective exploded view of a structural reinforcement for limiting longitudinal deflection during operation of an electrochemical cell stack module including non-conductive frames in accordance with one embodiment.

FIG. 8 is a perspective view of a structural reinforcement for limiting longitudinal deflection during operation of an electrolyzer including non-conductive frames in accordance with another embodiment.

FIG. 9 is a perspective view of a structural reinforcement for limiting radial or circumferential deflection during operation of an electrochemical cell stack module including non-conductive frames in accordance with another embodiment.

FIG. 10 is a perspective view of a two-piece cylindrical structural reinforcement for an electrochemical cell stack module.

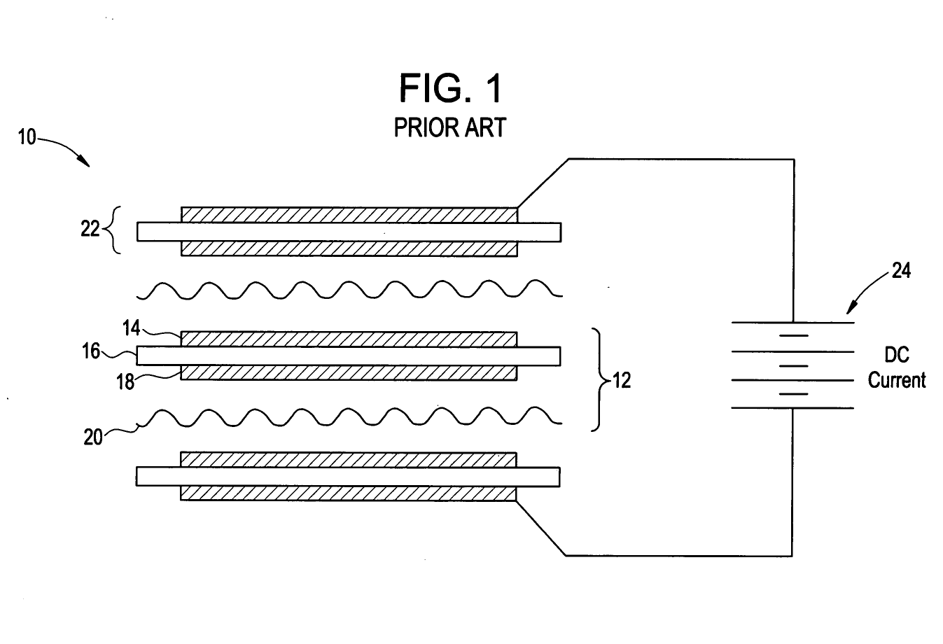

### DETAILED DESCRIPTION OF THE INVENTION

The disclosure describes various structural reinforcements for an electrochemical cell stacks configured with non-conductive stacks that minimize and/or prevent pressure related creep. Advantageously, the structural reinforcements described herein permit internal pressure to build up within the stacks with minimal and/or without any pressure related creep, resulting in increased the system efficiency. The structural reinforcement can be used with electrolyzers of a bilithic or a monolithic design. As used herein, the term electrochemical cell is generic and intended to encompass electrolytic cells, galvanic cells, as well as fuels cells such as, but not limited to, solid oxide fuel cells, polymer electrolyte membrane type fuel cells, alkaline fuel cells, and the like.

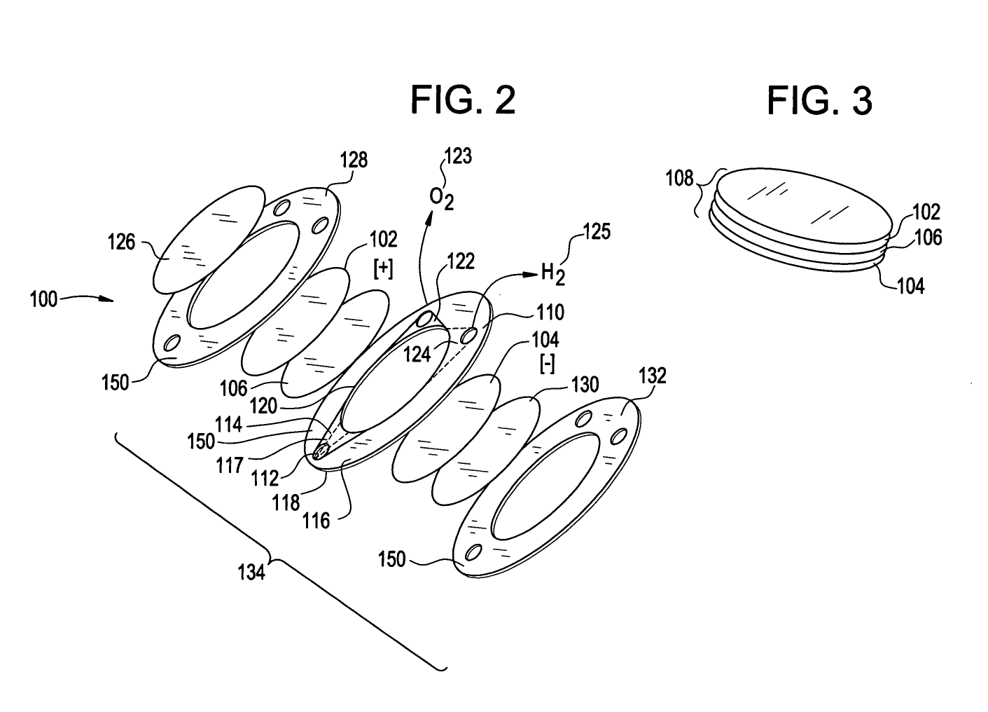

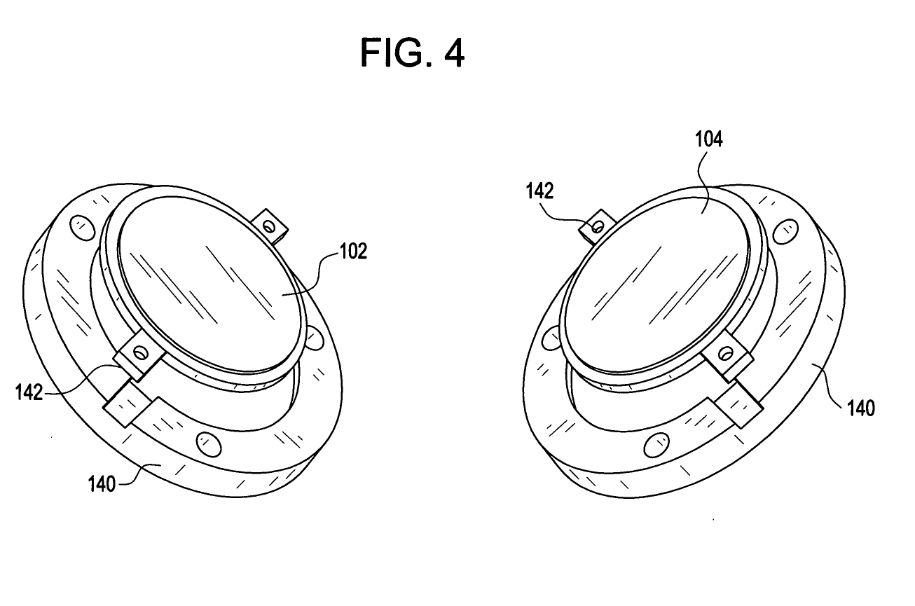

FIGS. 2-6 illustrate various views of an exemplary electrolyzer 100 that includes non-conductive frames for supporting various components of the electrolyzer. As will be discussed herein, the structural reinforcements described herein can be configured to limit longitudinal and/or radial deflection as a result of using the non-conductive frames in the electrolyzer, e.g., electrolyzer 100. The electrolyzer 100 comprises an anode 102 and a cathode 104 spaced apart from the anode 102. A bipolar plate 106 is interposed between the anode 102 and the cathode 104 to enable an electrical connection therebetween. As best shown in FIG. 3, the anode 102, bipolar plate 106 and cathode 104 are joined together to create an electrode insert 108. The electrochemical cell structure 100 (FIG. 2) further comprises an electrode frame 110. The circularly shaped electrode frame 110 comprises an electrolyte inlet 112, a first electrolyte flow path 114 on a top surface 116, a second electrolyte flow path 117 on a bottom surface 118 (shown with dotted lines), a seat 120, an oxygen flow path 122 on a top surface 116 and a hydrogen flow path 124 on a bottom surface 118 (shown with dotted lines). An electrode insert 108 is positioned on a seat 120. The electrochemical cell structure 100 further comprises a top diaphragm 126, a top diaphragm frame 128, a bottom diaphragm 130 and a bottom diaphragm frame 132. For purposes of discussion, in this embodiment, the top diaphragm frame 128, the top diaphragm 126, the electrode insert 108, the electrode frame 108, the bottom diaphragm 130 and the bottom diaphragm frame 132 form a repeat plate 134. An implementation of an alkaline electrolysis stack would include many, for example between about 10 to about 100, individual repeat plates 134. As shown in FIG. 4, each stack is typically capped with an end cap 140, an anode 102 and a current collector 142 at one end and an end cap 140, a cathode 104 and a current collector 142 at an opposite end.

In operation, an electrolyte is introduced via an inlet 112 (FIG. 2) and is distributed to the anode 102 by a first flow path 114 and to the cathode 104 by a second flow path 117. In addition, the electrolyte flows through the top membrane 126 and the bottom membrane 130 and creates an ionic bridge between adjacent repeat plates 134. A DC current is applied to the electrode inserts 108 and a portion of the electrolyte dissociates into oxygen and hydrogen at each anode 102 and cathode 104, respectively, within a representative stack. The oxygen and a portion of the electrolyte flow through oxygen flow path 122 to oxygen outlet 123 and the hydrogen and a portion of the electrolyte flow through hydrogen flow path 124 to hydrogen outlet 125. Additional flow paths (not shown) are provided between adjacent repeat plates 134 to allow the electrolyte to flow to one of the inlets 112, the oxygen outlet 123 and the hydrogen outlet 125.

As shown best in FIG. 2, the top diaphragm support 128, the electrode frame 110 and the bottom diaphragm support 132 components, of each repeat plate 134 are made of a non-conductive materials, and typically, although not necessarily, have the same general geometry. For purposes of clarity, these combined components are referred to as nonconductive frame 150. In one embodiment, non-conductive frame 150 comprises a material having a maximum working temperature in a range between about 60 degrees Celsius to about 120 degrees Celsius. This temperature range would support most alkaline electrolysis applications. In another embodiment, nonconductive frame 150 comprises a material having a maximum working temperature in a range between about 60 degrees Celsius to about 300 degrees Celsius. This temperature range would support most alkaline electrolysis and fuel cell applications as well as most proton exchange membranes (PEM) and acid electrolysis applications.

In an embodiment, the nonconductive frame 150 comprises a polymer, typically a polymer chemically resistant to caustic to avoid degradation during prolonged exposure to bases like KOH or NaOH. In another embodiment, the nonconductive frame 150 can also comprise a hydrolytically stable polymer. Suitable polymers include, but are not limited to, polyethylene, fluorinated polymers, polypropylene, and polysulfone, polyphenylenesulfide, polystyrene, and blends thereof. In preferred embodiments, the nonconductive frame 150 is manufactured with one or more polymers from the NORYL® resin family.

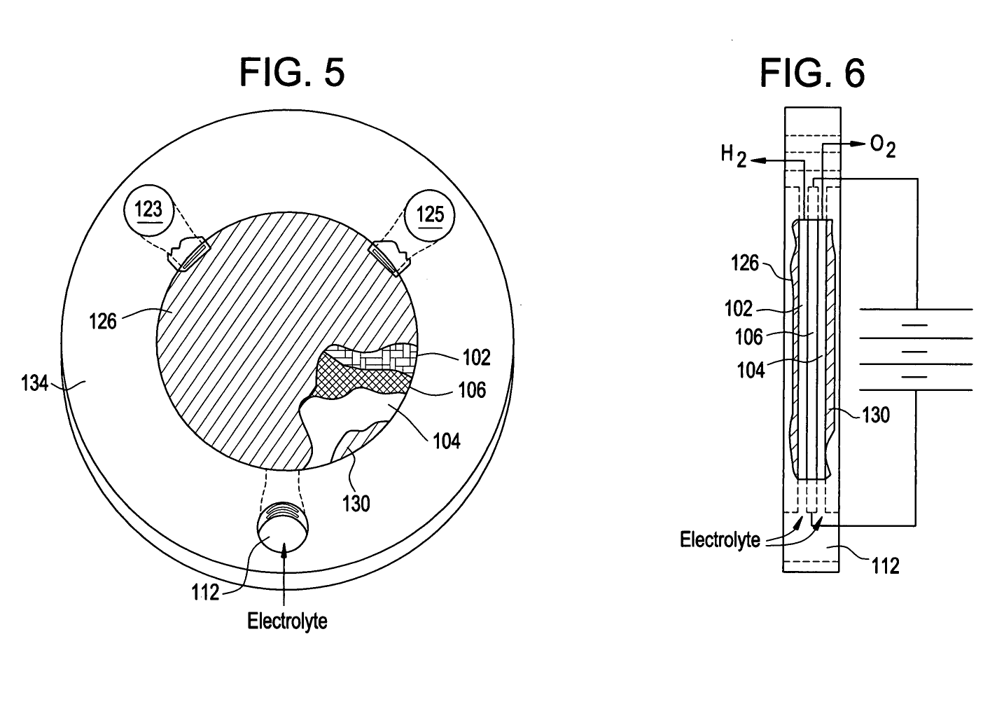

In reference to FIGS. 5 and 6, repeat plate 134 is depicted as a single unit. Each repeat plate 134 is constructed to provide an inlet 11 of the electrolyte. As best shown in FIG. 6, the electrolyte splits in to two streams on either side of the bipolar plate 106 and dissociates in to H₂ and O₂. The diaphragms 126 and 130 bound each side of the electrode insert to ensure the H₂ and O₂ do not mix between adjacent repeat plates 134. The construction of the exemplary repeat plate 134 is relatively simple and avoids the use of seals or gaskets. As depicted, the electrode inset 108 and the diaphragms 126 and 130 are supported and encased within the single piece non-conductive frame of repeat plate 134. The flow paths for the electrolyte are also defined by the single piece non-conductive frame of repeat plate 134, essentially removing any need for gasketing within said system.

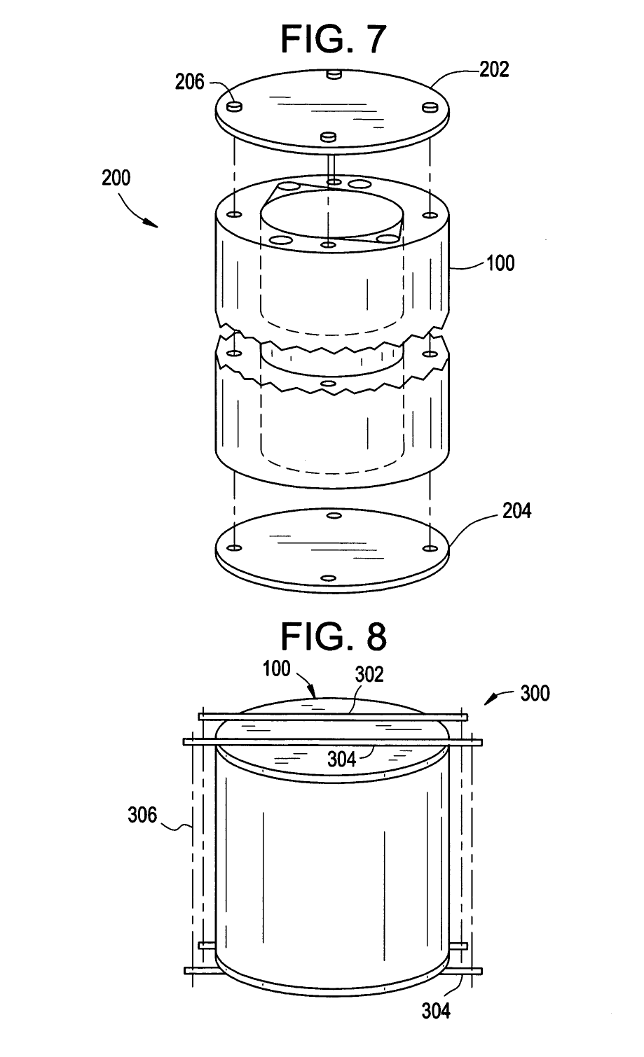

FIG. 7 illustrates a structural reinforcement 200 for an electrolyzer such as the one discussed above, (e.g., electrolyzer 100) that minimizes longitudinal deflection. The structural reinforcement includes rigid members 202 and 204 that form a sandwich about the electrolyzer 100. The rigid members 202, 204 are fastened to one another with at least one connector, e.g., fastener 206 so as to contain the electrolyzer 100 there between and minimize and/or prevent creep related to the nonconductive frame 150. The rigid members can be formed of any material sufficiently rigid to prevent creep from the stacked non-conductive frames 150 used in the electrolyzer 100. Likewise, the rigid members can be of any shape suitable to be configured to retain and prevent creep in the electrolyzer 100 during operation.

In one embodiment, the rigid members 202, 204 are fastened to one another with at least one connector 206 extending through the electrolyzer stack as shown in FIG. 7. Optionally, the current collector (see FIG. 4, current collector 142) can function as the rigid members 202 and/or 204. In other embodiments, each rigid member 202, 204 is fixedly attached directly to the electrolyzer stack.

In another embodiment, the rigid members 202, 204 are configured to be of a larger lateral dimension than the electrolyzer 100. In this embodiment, the rigid members 202, 204 have a portion that overlies the boundaries of the electrolyzer 100. The rigid members can thus be externally fastened about the periphery with a suitable fastener, e.g., bolts, clamps, tie rods, straps, and the like.

In another embodiment, the fasteners are internally positioned within the flow channels of the electrolyzer (see FIG. 2, for example flow paths 114, 117, 122, and/or 124). The fasteners can be disposed within chemically resistant sleeves or can be formed of chemically resistant materials suitable for the environment in which they are disposed. Of course, one of skill in the art will appreciate that the fasteners should also be made of a creep resistant material.

FIG. 8 illustrates a structural reinforcement 300 for limiting longitudinal deflection in accordance with another embodiment. The structural reinforcement comprises at least two rigid members in the form of straps 302, 304 disposed at each end of the electrolyzer 100. A fastener 306 secures the straps against the ends of the electrolyzer so as to prevent creep of the nonconductive frame 150 during operation. In the embodiment shown, the straps are externally fastened relative to the electrolyzer. Optionally, the fastener could be disposed within the flow channels of the electrolyzer as previously described.

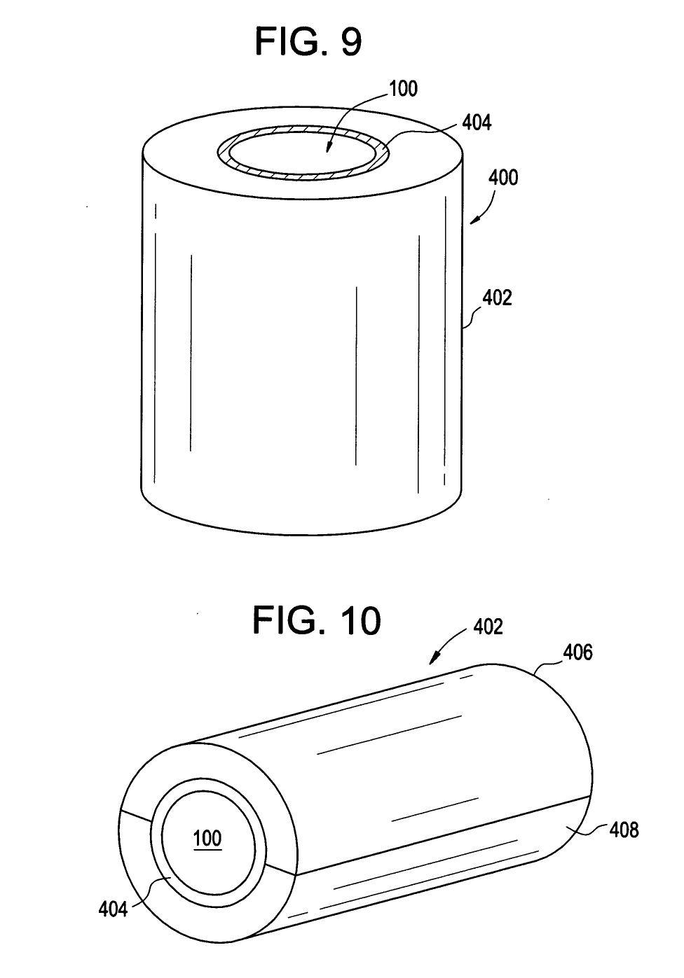

FIG. 9 illustrates structural reinforcement 400 for limiting radial deflection. Those of skill in the art will appreciate that the electrolyzer can have an overall cylindrical shape. The structural reinforcement 400 comprises a cylindrical sleeve 402 having an inner diameter slightly larger than the outer diameter of the electrolyzer 100. Optionally, a material 404 is disposed in the space between the outer surface of the electrolyzer stack and the inner surface of the cylindrical sleeve. The material transfers mechanical load from the electrolyzer stack to the cylindrical shell and resists creep deformation of the electrolyzer stack. In various embodiments, the material can comprise a liquid, a gel, a particulate, a creep-resistant solid, a combination thereof, and the like. In this manner, radial deflection is prevented. The cylindrical sleeve 402 can be formed of a composite, plastic, or metal that is sufficiently rigid so as minimize and/or prevent creep that is manifested in the radial direction. It should also be noted that additional reinforcement or limiting longitudinal deflection could be combined with the cylindrical sleeve 402 of structural reinforcement 400. For example, rigid members such as those shown in FIGS. 7 and 8 can be utilized in addition to the cylindrical sleeve 402. A suitable connector can be used to fasten the rigid members to the corresponding ends of the cylindrical sleeve, e.g., by adhesive, by bolts, by welding, and the like.

FIG. 10 illustrates the structural reinforcement 400 for limiting radial deflection, wherein the cylindrical shape is formed of two crescent shaped portions 406, 408. Although a two-piece construction is illustrated, one of skill in the art will appreciate that more than two pieces can be used to form the cylindrical shape of the structural reinforcement. Moreover, the various pieces are not intended to be limited to any particular shape.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An electrochemical cell stack module, comprising:
an electrochemical cell stack comprising one or more non-conductive frames, wherein the one or more non conductive frames support at least one of an anode, a cathode, a top diaphragm, and a lower diaphragm of a repeat plate; and
a structural reinforcement configured for containing the electrochemical cell stack, the structural reinforcement comprising a first rigid member, a second rigid member and at least one connector fixedly attached to at least one of said first and second rigid members along an axial direction and adapted to compress at least one of said rigid members to the end of the electrochemical cell stack.

2. The electrochemical cell stack module of claim 1, wherein the first rigid member, the second rigid member and the at least one connector are formed of a creep resistant material.

3. The electrochemical cell stack module of claim 1, wherein at least one of the first and second rigid members defines a current collector of the electrolyzer.

4. The electrochemical cell stack module of claim 1, wherein the at least one connector is internally disposed within the one or more non-conductive frames.

5. The electrochemical cell stack module of claim 4, wherein the at least one connector is fixedly attached to both the first rigid member and the second rigid member.

6. The electrochemical cell stack module of claim 4, wherein the at least one connector is fixedly attached to the first rigid member and the electrochemical cell stack.

7. The electrochemical cell stack module stack of claim 1, wherein the at least one connector is internally disposed within a flow path of the electrochemical cell stack.

8. The electrochemical cell stack module of claim 1, wherein the at least one connector is hollow and forms a flow path of the electrochemical cell stack.

9. The electrochemical cell stack module of claim 1, wherein the first and second rigid members and the at least one connector are configured to prevent longitudinal deflection during operation of the electrochemical cell stack.

10. The electrochemical stack module of claim 1, wherein the non-conductive frame comprises a material having a maximum working temperature in a range between about 50 degrees Celsius to about 300 degrees Celsius.

11. The electrochemical stack module of claim 1, wherein the one or more non-conductive frames comprise a material selected from a group consisting of polyethylene, fluorinated polymers, polypropylene, and polysulfone.

12. An electrochemical cell stack module, comprising:
a cylindrically shaped electrochemical cell stack comprising one or more non-conductive frames formed of a polymer, wherein the one or more non conductive frames support at least one of an anode, a cathode, a top diaphragm, and a lower diaphragm of a repeat plate; and
a structural reinforcement configured for containing the electrochemical cell stack, the structural reinforcement comprising a cylindrical sleeve having an inner diameter equal to or slightly larger than the cylindrically shaped electrochemical cell stack.

13. The electrochemical cell stack module of claim 12, wherein the structural reinforcement is formed of a creep resistant material.

14. The electrochemical cell stack module of claim 12, wherein the non-conductive frame comprises a material selected from a group consisting of polyethylene, fluorinated polymers, polypropylene, and polysulfone.

15. The electrochemical cell stack module of claim 12, wherein a material is disposed in a space formed between the outer surface of the electrochemical cell stack and the inner surface of the cylindrical sleeve.

16. The electrochemical cell stack module of claim 12, wherein the cylindrical sleeve is comprised of a non-conductive material.

17. The electrochemical cell stack module of claim 14, wherein the cylindrical sleeve comprises a wound filament.

18. An electrochemical cell stack module, comprising:
a cylindrically shaped electrochemical cell stack comprising one or more non-conductive frames, wherein the one or more non conductive frames support at least one of an anode, a cathode, a top diaphragm, and a lower diaphragm of a repeat plate; and
a structural reinforcement configured for containing the electrochemical cell stack, the structural reinforcement comprising a cylindrical sleeve having an inner diameter slightly larger than the cylindrically shaped electrolyzer stack, a first rigid member disposed against one end of the cylindrical sleeve, a second rigid member disposed against an other end of the cylindrical sleeve.

19. The electrochemical cell stack module of claim 18, wherein the first and second members are disposed against the cylindrical sleeve with at least one connector extending between the first and second members.

20. The electrochemical cell stack module of claim 18, wherein the first and second members are each attached directly to the cylindrical sleeve.
